(19) United States
(12) Patent Application Publication
(10) Pub. No.: US 2019/0018765 A1
(43) Pub. Date: Jan. 17, 2019

(54) TEST CASE GENERATION APPARATUS AND COMPUTER READABLE MEDIUM

(71) Applicant: MITSUBISHI ELECTRIC CORPORATION, Tokyo (JP)

(72) Inventor: Makoto ISODA, Tokyo (JP)

(73) Assignee: MITSUBISHI ELECTRIC CORPORATION, Tokyo (JP)

(21) Appl. No.: 16/067,183

(22) PCT Filed: Feb. 24, 2016
(86) PCT No.: PCT/JP2016/055486

§ 371 Date: Jun. 29, 2018

(51) Int. Cl. G06F 11/36

(52) U.S. Cl. CPC G06F 11/3684; G06F 11/3676; G06F 11/3664; G06F 11/3688

(57) ABSTRACT

Using, as a target pattern, each of combinations of a plurality of input conditions, a plurality of output conditions, and a plurality of arrival points each at which attainment of a process is confirmed by a test method based on a software structure, a test case generation apparatus determines whether or not generation of a test case is possible. The test case is formed of values of input and output signals and enables simultaneous checking of an arrival point and an input-output condition being a pair of an input condition and an output condition in the target pattern. With this arrangement, the test case generation apparatus identifies a set of the test cases that enable checking of each of the plurality of input conditions, each of the plurality of output conditions, and each of the plurality of arrival points.

### TECHNICAL FIELD

The present invention relates to a technology for generating a test case in system development.

### BACKGROUND ART

Control software that is installed in a control apparatus has rapidly increased in size and complexity, due to computerization of a control function for accommodating multi-functionality and improvement in added value. An increase in variation of the control software due to its derivation model and a destination point difference is further expected. In order to maintain and strengthen profitability under such circumstances, improvement in productivity of control software development needs to be tackled.

It is a rare practice to newly develop a control apparatus from the beginning, so that it is often the case that an existing control apparatus is used for functional improvement. Therefore, when a conventional development process is applied for development of control software, problems associated with resources in a test process have become apparent.

Specifically, there are a problem that determination of whether an integration test with respect to a functional modification is adequate is difficult, so that a workload is postponed to a system test, and a problem that a workload for a unit test increases with respect to a software component whose functional modification and whose addition are often made for each model. These problems have become a main factor for pushing up development cost.

It is necessary to clarity a requirement for the test process, as a premise for solution to the above-mentioned problems.

The requirement for the test process is set to simultaneously guarantee the following (Requirement 1) and (Requirement 2), using a functional safety standard as a reference:

(Requirement 1): To guarantee coverage based on an external function of the control software.

(Requirement 2): To guarantee coverage based on the internal structure of the control software.

As specific examples of the functional safety standard, there are DO-0178B for the aviation industry and ISO26262 for the automobile industry.

Conventional test technologies each guarantee the function-based coverage in (Requirement 1) and the structure-based coverage in (Requirement 2) separately (see Patent Literature 1 and Non-Patent Literature 1).

### CITATION LIST

### Patent Literature

Patent Literature 1: JP 2008-276556 A

### Non-Patent Literature

Non-Patent Literature 1: Yuusuke Hashimoto and Shin Nakajima, “A Tool Chain to Combine Software Model Checking and Test Case Generation”, Software Engineering Symposium 2011, September 2011.

### SUMMARY OF INVENTION

### Technical Problem

In the conventional test technologies, a portion of the structure-based coverage in (Requirement 2) that could not be guaranteed is compensated for by manual work after guaranteeing the function-based coverage in (Requirement 1). Therefore, a workload for the structure-based coverage in (Requirement 2) increases, and omission in the work cannot be eliminated. (Requirement 2) may not be therefore achieved.

An object of the present invention is to identify test cases that can simultaneously guarantee a function-based coverage (in Requirement 1) and a structure-based coverage (in Requirement 2).

### Solution to Problem

A test case generation apparatus according to the present invention may include:

a pattern generation unit to generate combination patterns indicating combinations of a plurality of input conditions for input signals for a target system, a plurality of output conditions for output signals for the target system, and a plurality of arrival points in the target system each at which attainment of a process is confirmed by a test method based on a software structure; and

a test case generation unit to set, as a target pattern, each of the combinations indicated by the combination patterns generated by the pattern generation unit and determine whether or not generation of a test case that comprises values of the input signals and enables simultaneous checking of an input-output condition and a corresponding one of the plurality of arrival points in the target pattern is possible, thereby identifying a set of test cases that enable checking of each of the plurality of input conditions, each of the plurality of output conditions, and each of the plurality of arrival points, the input-output condition being a pair of an input condition and an output condition in the target pattern.

### Advantageous Effects of Invention

In the present invention, it is determined whether or not generation of the test case that enables simultaneous checking of the input-output condition and the arrival point is possible with respect to each combination of the input condition, the output condition, and the arrival point. With this arrangement, it is possible to identify the test cases that can simultaneously guarantee the function-based coverage (in Requirement 1) and the structure-based coverage (in Requirement 2).

### BRIEF DESCRIPTION OF DRAWINGS

FIG. 1 is a configuration diagram of a test case generation apparatus 10 according to a first embodiment.

FIG. 2 is a diagram illustrating a typical configuration example of a target system 30 according to the first embodiment.

FIG. 3 is a flowchart illustrating operations of the test case generation apparatus 10 according to the first embodiment.

FIG. 4 is an explanatory diagram of input conditions 31 and output conditions 32 according to the first embodiment.

FIG. 5 is an explanatory diagram of an implementation product 125 according to the first embodiment.

FIG. 6 is an explanatory diagram of an analysis implementation product 33 according to the first embodiment.

FIG. 7 is an explanatory diagram of combination patterns according to the first embodiment.

FIG. 8 is an explanatory diagram of a conditional implementation product 34 according to the first embodiment.

FIG. 9 is an explanatory diagram of coverage information 35 according to the first embodiment.

FIG. 10 includes explanatory diagrams of test cases 36 according to the first embodiment.

FIG. 11 is an explanatory diagram of a test case generation process in step S5 according to the first embodiment.

FIG. 12 is a diagram illustrating a specific example of the test case generation process in step S5 according to the first embodiment.

FIG. 13 is an explanatory diagram of a specific example of a structure-based test method according to the first embodiment.

FIG. 14 is an explanatory diagram of a specific example of a function-based test method (for a flow) according to the first embodiment.

FIG. 15 is an explanatory diagram of a specific example of a function-based test method (using values) according to the first embodiment.

FIG. 16 is a configuration diagram of a test case generation apparatus 10 according to a first variation example.

FIG. 17 is an explanatory diagram of a repetition system 37 according to a second embodiment.

### DESCRIPTION OF EMBODIMENTS

### First Embodiment

Description of Configuration

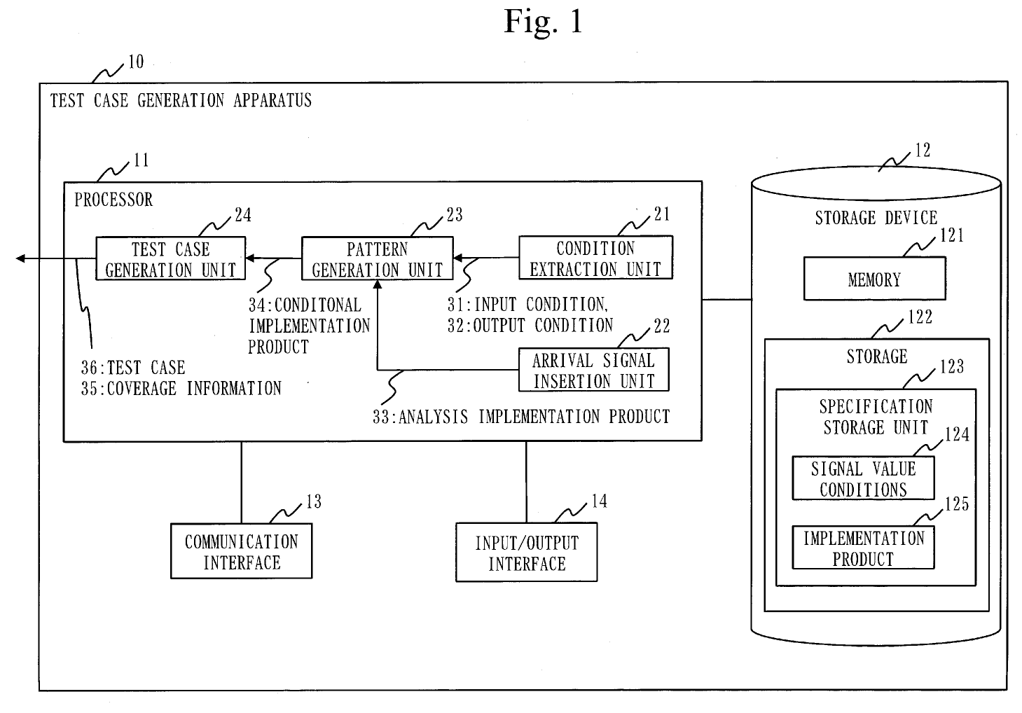

A configuration of a test case generation apparatus 10 according to a first embodiment will be described with reference to FIG. 1.

The test case generation apparatus 10 is a computer for generating a test case 36 of a target system 30.

The test case generation apparatus 10 includes hardware such as a processor 11, a storage device 12, a communication interface 13, and an input/output interface 14. The processor 11 is connected to the other hardware via signal lines and controls these other hardware.

The processor 11 is an integrated circuit (IC) to perform processing. Specifically, the processor 11 is a central processing unit (CPU), a digital signal processor (DSP), or a graphics processing unit (GPU).

The storage device 12 includes a memory 121 and a storage 122. Specifically, the memory 121 is a random access memory (RAM). Specifically, the storage 122 is a hard disk drive (HDD). Alternatively, the storage 122 may be a portable storage medium such as a secure digital (SD) memory card, a compact flash (CF), a NAND flash, a flexible disk, an optical disk, a compact disk, a blue ray (registered trade mark) disk, or a DVD.

The communication interface 13 is a device to connect an apparatus such as an external server. As a specific example, the communication interface 13 is a connection terminal of Universal Serial Bus (USB), IEEE1394.

The input/output interface 14 is a device to connect an input apparatus such as a keyboard or a mouse and a display apparatus such as a display. As a specific example, the input/output interface 14 is a connection terminal of USB, a high-definition multimedia interface (HDMI) (registered trade mark).

The test case generation apparatus 10 includes a condition extraction unit 21, an arrival signal insertion unit 22, a pattern generation unit 23, and a test case generation unit 24, as functional components. A function of each unit of the condition extraction unit 21, the arrival signal insertion unit 22, the pattern generation unit 23, and the test case generation unit 24 is implemented by software.

A program to implement the function of each unit in the test case generation apparatus 10 is stored in the storage 122 of the storage device 12. This program is loaded into the memory 121 by the processor 11 and is executed by the processor 11. This causes the function of each unit of the test case generation apparatus 10 to be implemented.

The storage 122 of the storage device 12 implements a specification storage unit 123 that has stored functional specifications of the target system 30.

Signal value conditions 124, an implementation product 125, and so on are stored in the specification storage unit 123. The signal value conditions 124 indicate an input condition for each of a plurality of input signals for the target system 30 and an output condition for each of a plurality of output signals for the target system 30 in external specifications of the target system 30. The input condition and the output condition are each formed of conditions such as a signal value range and a boundary value of a signal value. The implementation product 125 is the one such as a program code that has implemented the target system 30, or a processing model representing a processing flow of the target system 30, in which at least the processing flow of the target system 30 has been identified.

Information, data, signal values, and variable values indicating results of processes of the functions of the respective units that are implemented by the processor 11 are stored in the memory 121 or a register or a cache memory in the processor 11. In the following expression, the description will be given, assuming that the information, the data, the signal values, and the variable values indicating the results of the processes of the functions of the respective units that are implemented by the processor 11 are stored in the memory 121.

The program to implement each function that is implemented by the processor 11 has been assumed to be stored in the storage device 12. This program may be, however, stored in a portable storage medium such as a magnetic disk, a flexible disk, an optical disk, a compact disk, a blue ray (registered trademark) disk, or a DVD.

FIG. 1 illustrates only one processor 11. There may be, however, a plurality of the processors 11, and the plurality of the processors 11 may cooperate and execute the program to implement each function.

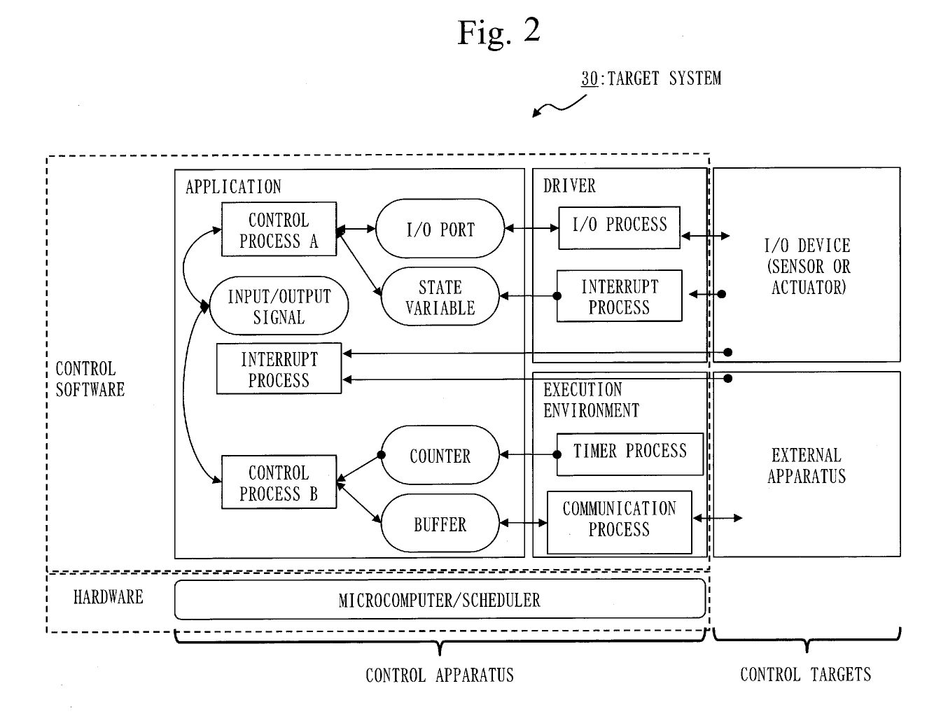

A typical configuration of the target system 30 according to the first embodiment will be described with reference to FIG. 2. The configuration illustrated in FIG. 2 is a typical one, and the configuration of the target system 30 is not limited to this.

The target system 30 is configured by connection of a control apparatus constituted from control software and hardware and a control target, using digital signal lines or analog signal lines. The control software is constituted from layers of an application to implement functions, an execution environment to implement a scheme of functional operations such as communication and scheduler, and a driver for controlling the control target. The hardware is constituted from a microcomputer, a scheduler, and so on. The control target is each of an external apparatus and an IO (Input/Output) device such as a sensor or an actuator.

The application is constituted from a plurality of control processes which are periodically started in a specified order and whose contents are changed, depending on values of a state variable, a counter, a buffer, and so on held inside. The execution environment and the driver are constituted from an I/O process such as a register access, an interrupt process having a higher priority than each control process, a timer process, and a communication process. A control operation is executed every moment in the target system 30 while exchanging data among the application, the execution environment, and the driver.

Description of Operations

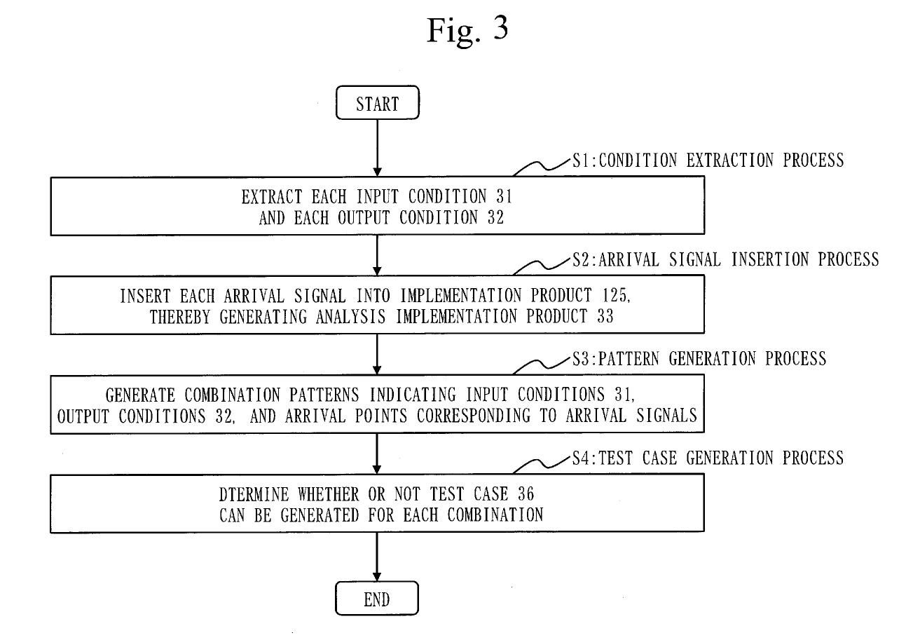

Operations of the test case generation apparatus 10 according to the first embodiment will be described with reference to FIGS. 3 to 15.

The operations of the test case generation apparatus 10 according to the first embodiment correspond to a test case generation method according to the first embodiment. The operations of the test case generation apparatus 10 according to the first embodiment correspond to a test case generation program procedure according to the first embodiment.

An overall operation of the test case generation apparatus 10 according to the first embodiment will be described with reference to FIGS. 3 to 10.

(Step S1 in FIG. 3: Condition Extraction Process)

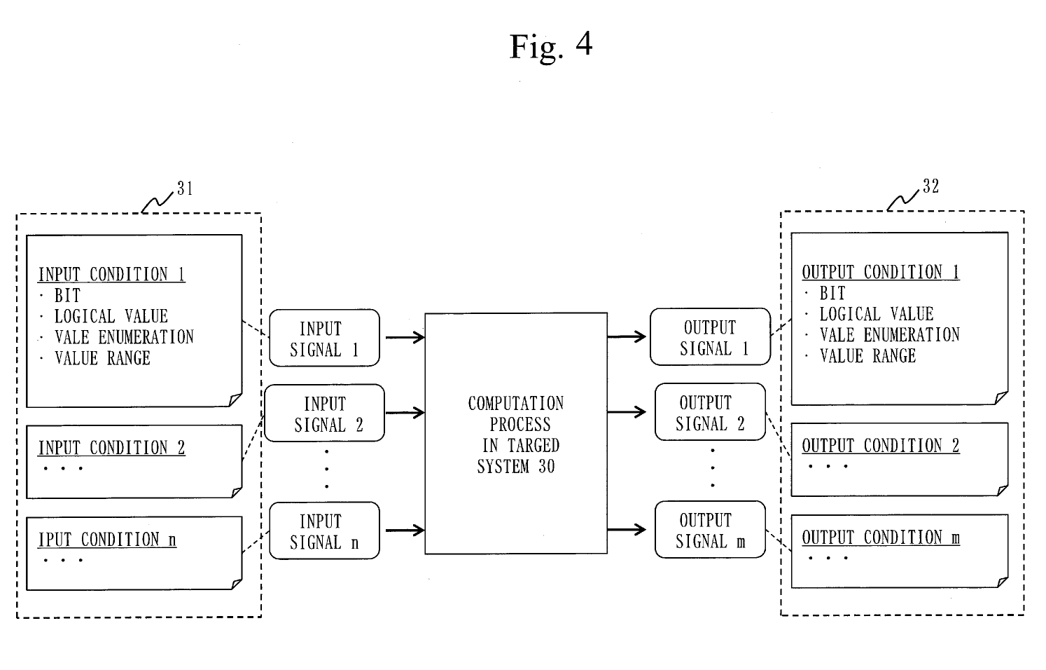

The condition extraction unit 21 reads the signal value conditions 124 stored in the specification storage unit 123 of the storage 122, and extracts, from the signal value conditions 124, an input condition 31 for each input signal and an output condition 32 for each output signal, as illustrated in FIG. 4. This extracts a plurality of input conditions 31 and a plurality of output conditions 32. Referring to FIG. 4, input conditions 1 to input conditions n that are respectively the input conditions 31 for an input signal 1 to an input signal n and output conditions 1 to output conditions m that are respectively the output conditions 32 for an output signal 1 to an output signal m are extracted. The condition extraction unit 21 writes, into the memory 121, the plurality of input conditions 31 and the plurality of output conditions 32 that have been extracted.

Each of the input conditions and the output conditions is defined by conditions of a bit, a logical value, a value enumeration, and a value range, or a combination of the conditions. The bit indicates one of a valid value and an invalid value of a bit pattern that can be taken by each input signal or each output signal. The logical value indicates a true or false value that can be taken by each input signal or each output signal. The value enumeration indicates discrete valid values or discrete invalid values that can be taken by each input signal or each output signal. The value range indicates successive valid values or successive invalid values that can be taken by each input signal or each output signal. In the combination of the conditions, at least any ones of the bit, the logical value, the value enumeration, and the value range are connected by a logical operator.

The input condition 31 and the output condition 32 each correspond to a check point of a test method based on a software function.

(Step S2 in FIG. 3: Arrival Signal Insertion Process)

The arrival signal insertion unit 22 reads the implementation product 125 stored in the specification storage unit 123 of the storage 122 and inserts arrival signals to a plurality of arrival points in the target system 30, thereby generating an analysis implementation product 33. The arrival signal insertion unit 22 writes, into the memory 121, the analysis implementation product 33 that has been generated.

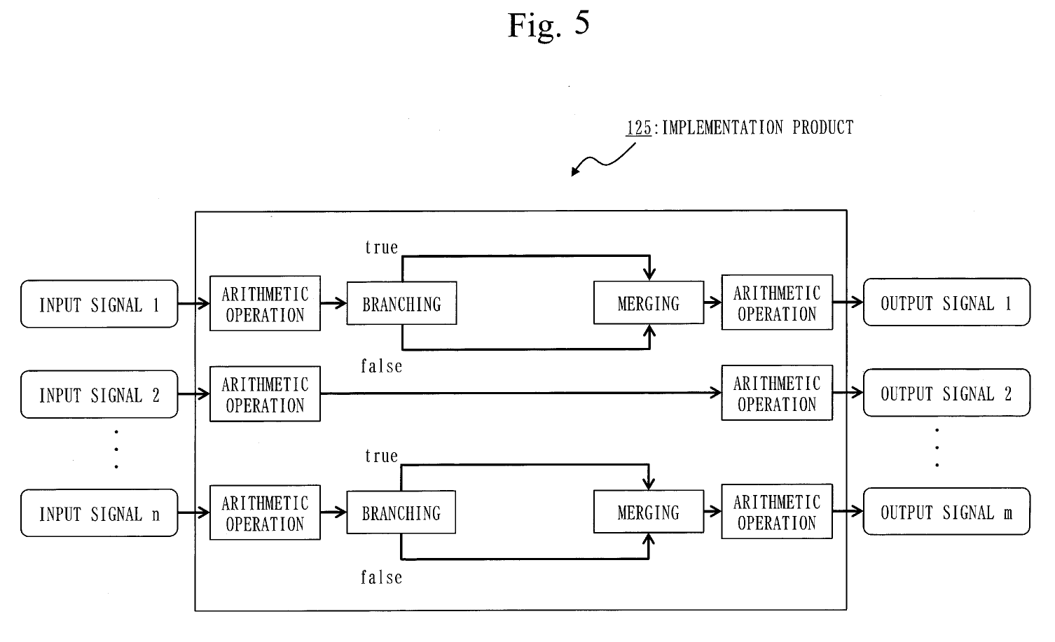

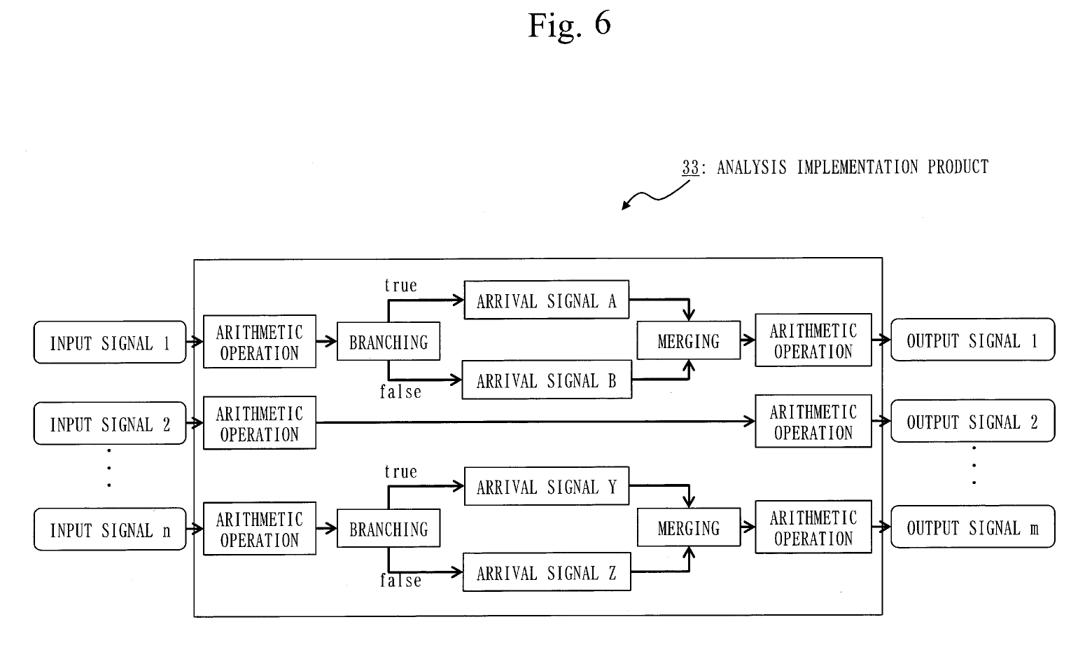

The arrival points each mean a check point at which attainment of a process is confirmed by a test method based on a software structure and is used for analyzing whether or not an internal structure can be executed. As a specific example, if the test method based on the software structure is branch coverage, the arrival points are all branch destinations in the implementation product 125. If the implementation product 125 is a processing model illustrated in FIG. 5, the analysis implementation product 33 is the one in which the arrival signals are embedded in all the branch destinations of the implementation product 125, as illustrated in FIG. 6.

Though only arithmetic operations, branchings, and mergings are included in the target system 30 in FIG. 5, a process such as looping may also be included in addition to the arithmetic operations, the branchings, and the mergings.

(Step S3 in FIG. 3: Pattern Generation Process)

The pattern generation unit 23 reads, form the memory 121, the plurality of input conditions extracted in step S1, the plurality of output conditions extracted in step S1, and the analysis implementation product 33 generated in step S2. The pattern generation unit 23 generates combination patterns indicating combinations of the plurality of input conditions, the plurality of output conditions, and the plurality of arrival points corresponding to the arrival signals embedded in the analysis implementation product 33. The pattern generation unit 23 writes, into the memory 121, the combination patterns that have been generated.

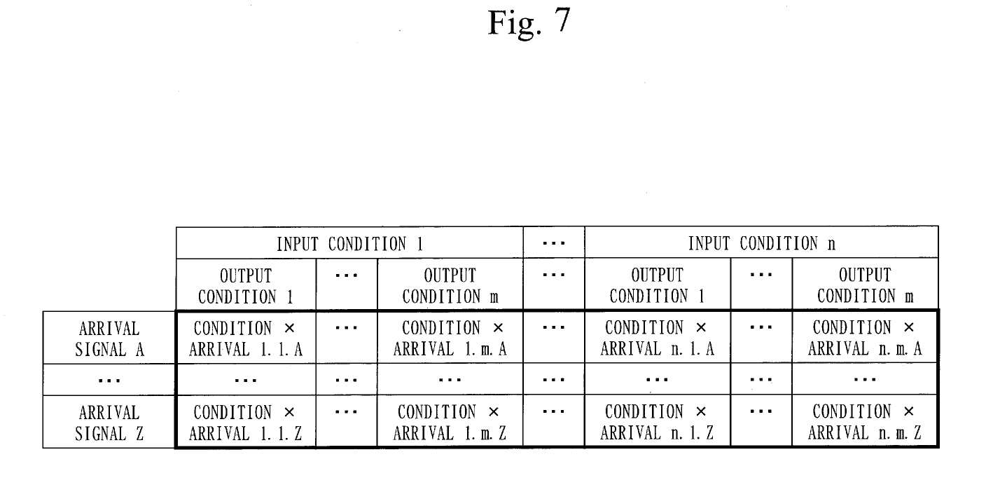

As a specific example, when the input conditions 31 and the output conditions 32 that are illustrated in FIG. 4 are read, and when the analysis implementation product 33 illustrated in FIG. 6 is read, the pattern generation unit 23 generates combination patterns illustrated in FIG. 7. As a result, 1. 1 . A to n. m. Z, which have been each given as a subscript to “condition×arrival”, are generated as combinations indicated by the combination patterns.

Using, as a target pattern, each combination that has been generated, the pattern generation unit 23 generates a conditional implementation product 34 by embedding the input condition and the output condition of the target pattern in the analysis implementation product 33 and retaining only the arrival signal corresponding to the arrival point in the target pattern. The pattern generation unit 23 writes, into the memory 121, the conditional implementation product 34 for each generated combination.

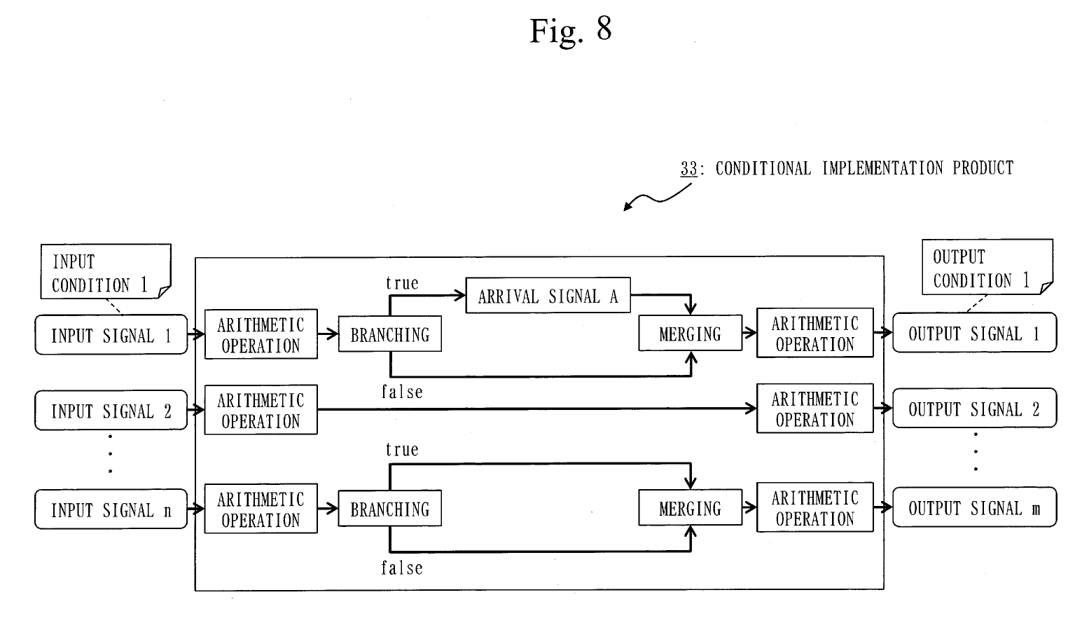

As a specific example, when the target pattern is the combination 1. 1. A illustrated in FIG. 7, the pattern generation unit 23 generates the conditional implementation product 34 in which the input condition 1, the output condition 1, and an arrival signal A have been embedded, as illustrated in FIG. 8.

(Step S4 in FIG. 3: Test Case Generation Process)

The test case generation unit 24 sets each combination generated in step S3 as the target pattern. Then, the test case generation unit 24 determines whether or not generation of a test case 36 is possible. The test case 36 is formed of values that satisfy a plurality of the input conditions 31 and a plurality of the output conditions 32 and enables simultaneous checking of the arrival point and an input-output condition being a pair of the input condition and the output condition in the target pattern. With this arrangement, the test case generation unit 24 identifies a set of the test cases 36 that enable checking of each of the plurality of input conditions 31 extracted in step S1, each of the plurality of output conditions 32 extracted in step S1, and each of the plurality of arrival points corresponding to the arrival signals inserted in step S2.

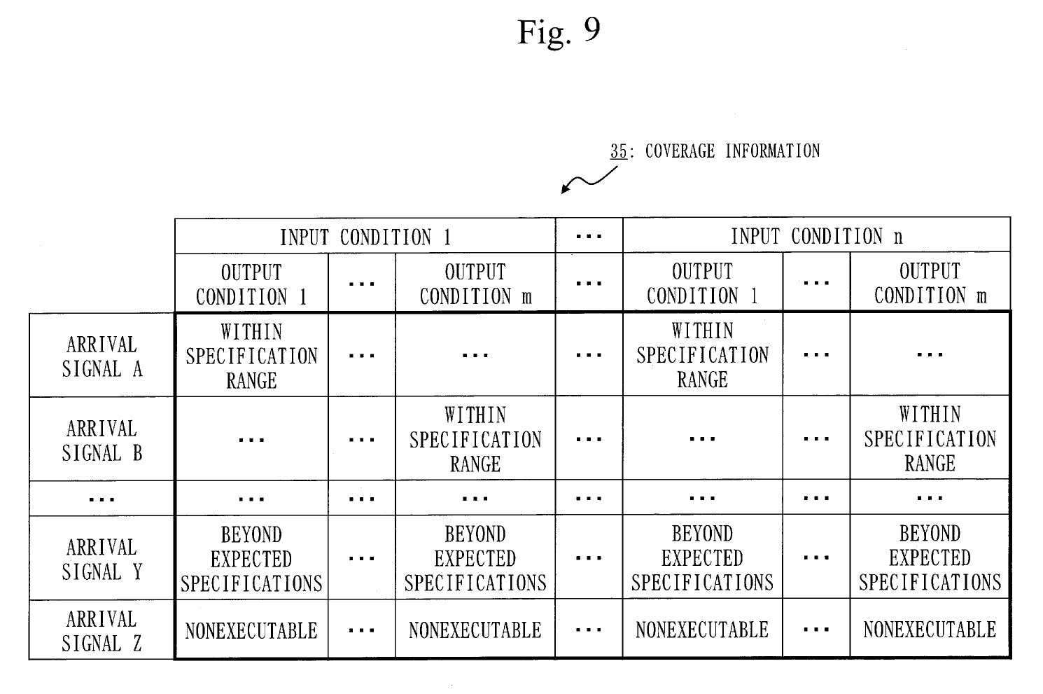

The test case generation unit 24 generates coverage information 35 indicating that each combination is one of being within a specification range, being beyond expected specifications, and being nonexecutable according to a result of the determination as to whether or not the test case 36 can be generated, as illustrated in FIG. 9.

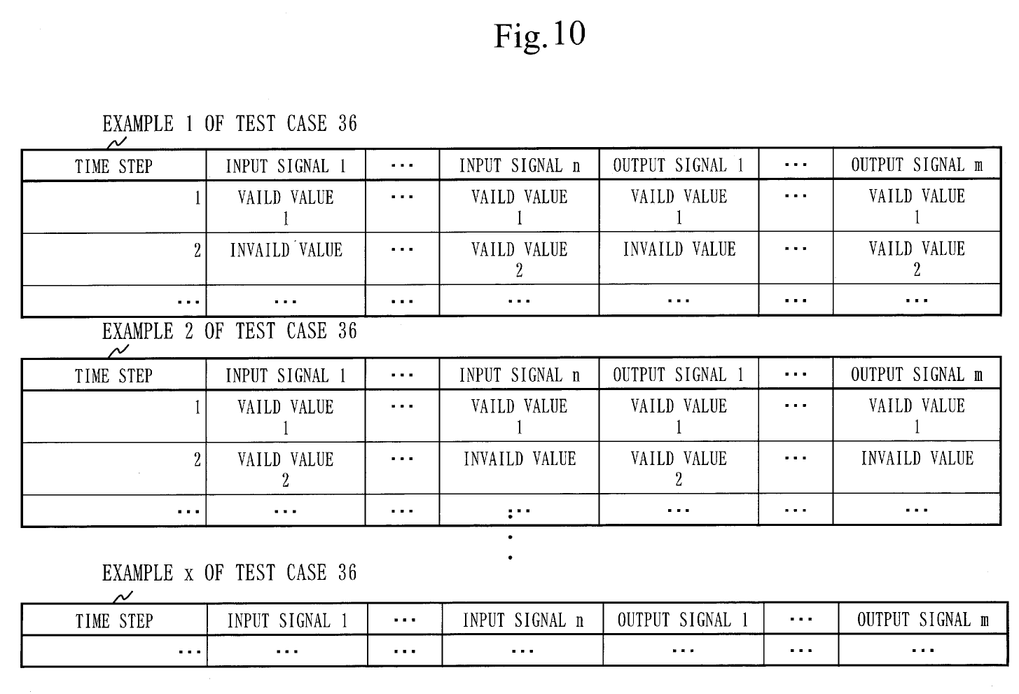

The test case generation unit 24 also extracts, from one or more of the combinations each for which the generation has been determined to be possible, the combinations that enable checking of each of the plurality of input conditions 31, each of the plurality of output conditions 32, and each of the plurality of arrival points and generates the test cases 36 with respect to the combinations that have been extracted. Each test case 36 is a sequence of the input signals and a sequence of the output signals on a time axis. As a specific example, the test case 36 is formed of values of the input signal 1 to the input signal n and values of the output signal 1 to the output signal m for each time step, as illustrated in FIG. 10. An example of each test case 36 in FIG. 10 corresponds to one of the combinations indicated by the combination patterns.

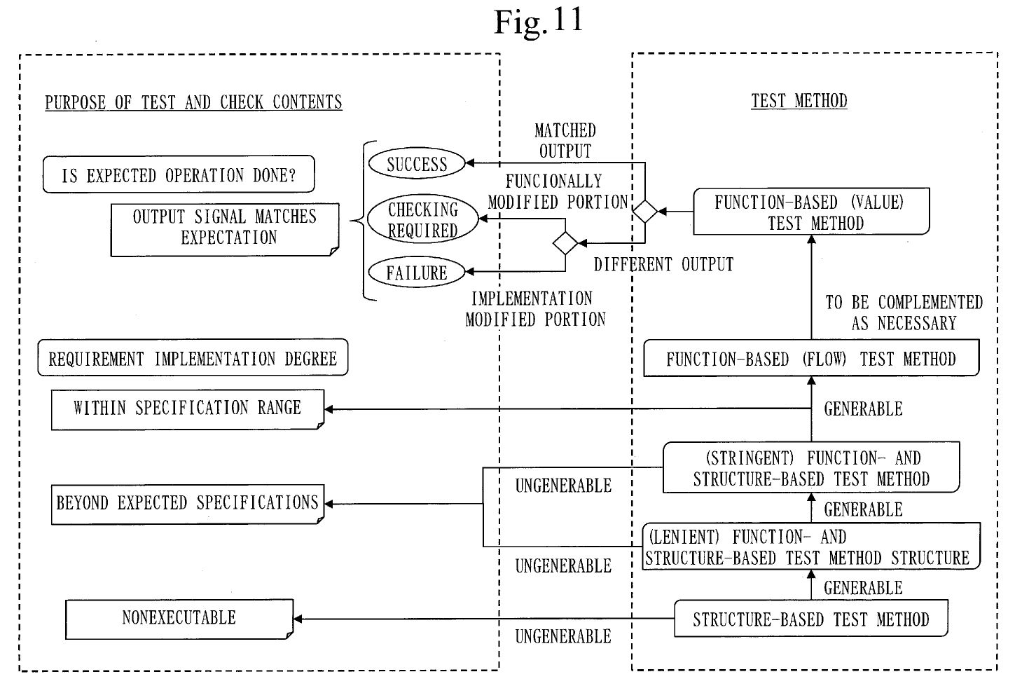

The test case generation process in step S4 according to the first embodiment will be described with reference to FIG. 11.

The process illustrated in FIG. 11 is executed, using each combination as a target pattern. By execution of the process illustrated in FIG. 11, a requirement implementation degree and execution of an expected operation with respect to the target pattern are identified, as given by a test purpose and check contents.

As the requirement implementation degree, it is identified whether each combination is one of being within the specification range, being beyond the expected specifications, and being nonexecutable. Being within the specification range is a case where the combination is executable as a result of structure coverage analysis and an intended requirement has been implemented. Being beyond the expected specifications is a case where the combination is not executed as the result of the structure coverage analysis and an unintended requirement has entered. Being nonexecutable is a case where the combination is nonexecutable as the result of the structure coverage analysis.

As execution of the expected operation, it is identified whether each combination is one of a success, a failure, and to be checked. The success is a case where when a specific value is given as the input signal, the value of the output signal matches an expected value. To be checked is a case where when the specific value is given as the input signal, the value of the output signal does not match the expected value and a target portion of the test case is a functionally modified portion. The failure is a case where when the specific value is given as the input signal, the value of the output signal does not match the expected value and the target portion of the test case is not with respect to the functionally modified portion and is an implementation modified portion.

Method 1 being a structure-based test method, Method 2 being a (lenient) function- and structure-based test method, Method 3 being a (stringent) function- and structure-based test method, Method 4 being a function-based (flow) test method, and Method 5 being a function-based (value) test method are employed for the process illustrated in FIG. 11.

Method 1: The structure-based test method is a method based on the propriety of implementation of a software internal structure. As a specific example of Method 1, the branch coverage, or MC/DC (Modified Condition/Decision Coverage) may be pointed out. Not only one structure-based test method but also a plurality of the structure-based test methods may be used as Method 1.

Method 2: The (lenient) function- and structure-based test method is the one in which, among methods that meet both of criteria of the test method based on the software function and the test method based on the software structure, a criterion with respect to the function is relatively lenient. As a specific example of Method 2, a combination of equivalence partitioning and the branch coverage may be pointed out. Not only one function- and structure-based test method but also a plurality of the function- and structure-based test methods may be used as Method 1.

Method 3: The (stringent) function- and structure-based test method is the one in which, among the methods that meet both of the criteria of the test method based on the software function and the test method based on the software structure, the criterion with respect to the function is relatively stringent. That is, Method 3 is a method that simultaneously meets both of the criteria of the test method based on the software structure and the test method based on the software function whose criterion is more stringent than that of Method 2. As a specific example of Method 3, a combination of boundary value analysis and the branch coverage may be pointed out. Not only one function- and structure-based test method but also a plurality of the function- and structure-based test methods may be used as Method 1.

Method 4: The function-based (flow) test method is the one in which, among the test methods based on the software function, input values that will influence a processing flow of the target system 30 in external functional specifications is used as a reference. As a specific example of Method 4, a combination of representative values (boundary values) may be pointed out. Not only one function-based test method but also a plurality of the function-based test methods may be used as Method 1.

Method 5: The function-based (value) test method is a method in which, among the test methods based on the software function, a match between an output signal value and an expected value in the external functional specifications is used as a criterion. As a specific example of Method 5, a Back-to-Back test may be pointed out.

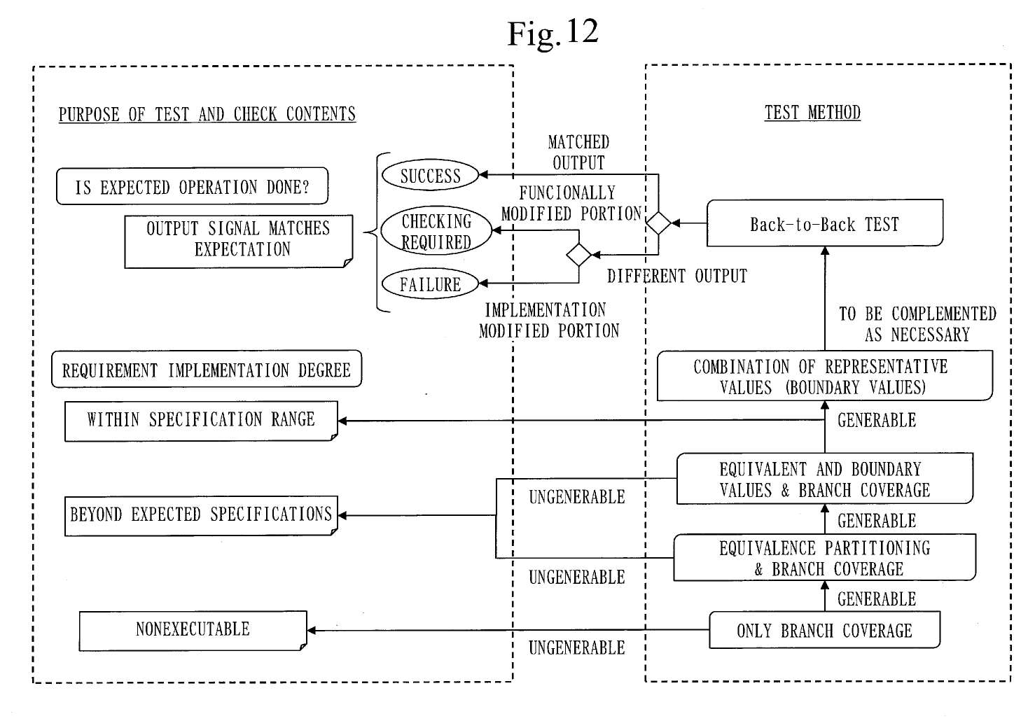

Accordingly, the process in FIG. 11 can be embodied as illustrated in FIG. 12. Referring to FIG. 12, the branch coverage is used as Method 1, the combination of the equivalence partitioning and the branch coverage is used as Method 2, the combination of equivalent values and boundary values and the branch coverage is used as Method 3, the combination of the representative values (boundary values) is used as Method 4, and the Back-to-Back test is used as Method 5. The equivalent values and the boundary values are for a method of the combination of the equivalence partitioning and the boundary analysis. Since the combination of the representative values (boundary values) is too stringent for simultaneously satisfying the branch coverage, the equivalent values are included to weaken the condition.

Preferably, the test method based on the software structure used herein is the same as the test method used in step S2.

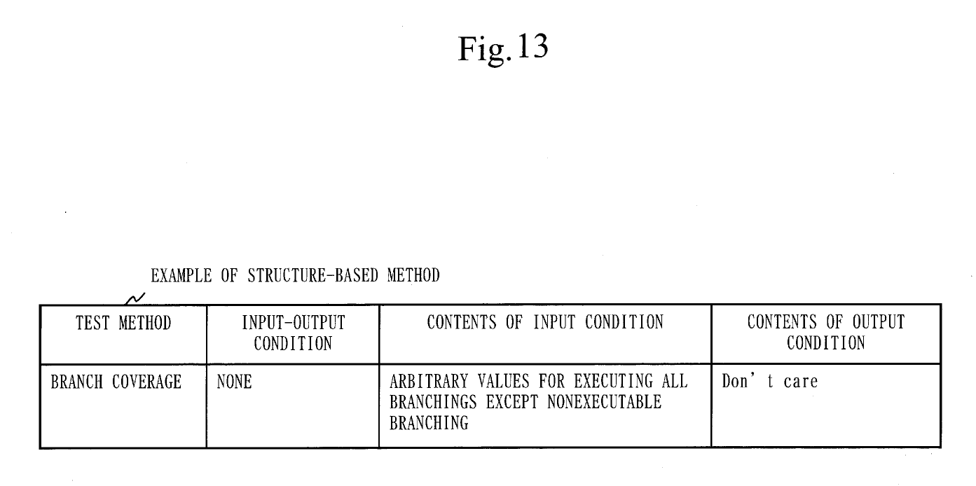

A determination condition of the branch coverage that is the specific example of the structure-based test method in each of Method 1 to Method 3 is as illustrated in FIG. 13.

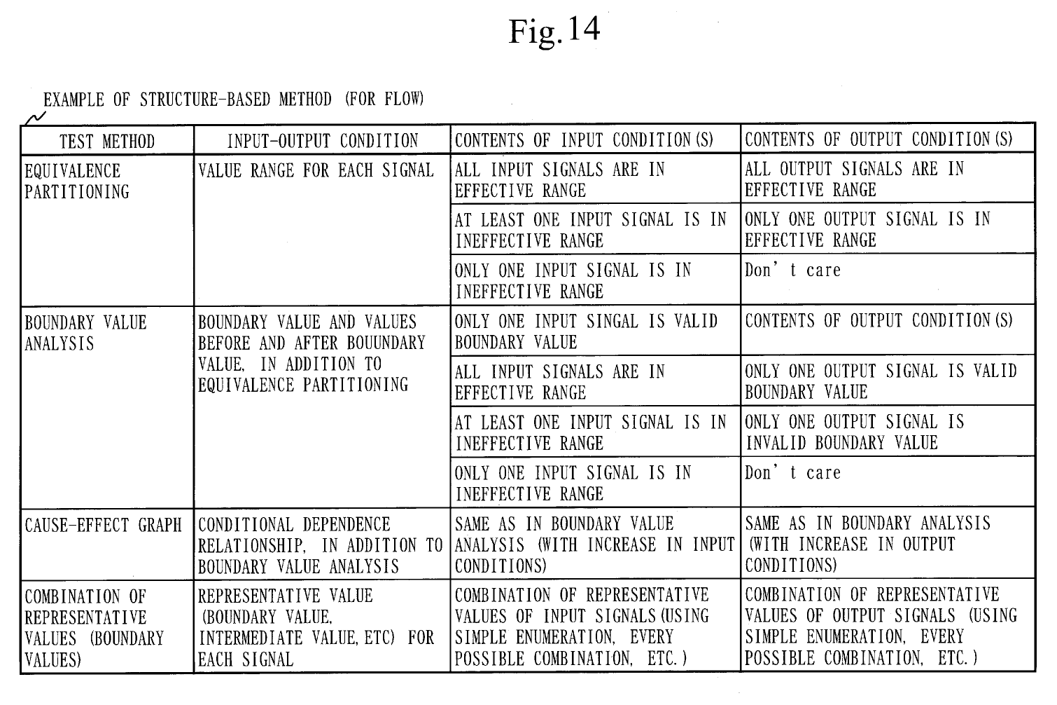

Determination conditions of the equivalence partitioning, the boundary value analysis, a cause-effect graph, the combination of the representative values (boundary values) that are the specific examples of the function-based test methods in Method 2 and Method 3, and the function-based (flow) test method in Method 4 are as illustrated in FIG. 14. There are three rows each indicating contents of the input condition and contents of the output condition in the equivalence partitioning. This means correspondence between the contents of the input condition and the contents of the output condition described in a same row. That is, an uppermost row describes a condition that if all input signals are in an effective range, all output signals should be in an effective range. When the equivalence partitioning is used, generation of the test cases 36 is determined to be possible when the test cases 36 accommodating respective conditions in the three rows can be generated. If one of the test cases 36 cannot be generated even due to the condition described in one raw, the generation of the test cases 36 is determined not to be possible. As in the case of the equivalence partitioning, the same holds true for the case of the boundary value analysis as well.

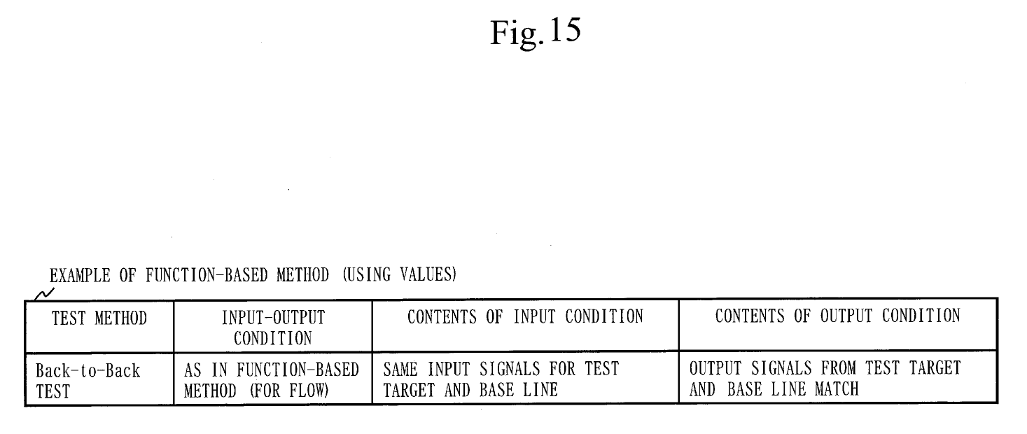

A determination condition of the Back-to-Back test that is the specific example of the function-based (value) test method in Method 5 is as illustrated in FIG. 15. A base line refers to a version of the target system 30 in which a result of a review, a test, or the like has been approved and whose configuration management has been performed. Therefore, as a principle, output signal values of the base line and a version to be tested except for a functionally modified portion match. An input-output condition is described to be the same as in the case of the function-based (flow) test method. This means that the same condition as an input-output condition in Method 4 is applied.

In the following description, the description will be given, assuming a flow in which Method 1 to Method 5 are sequentially executed. The execution order of these methods is not, however, limited to this, and these methods may be executed in any order if dependence relationships among the methods indicated by arrows in FIGS. 11 and 12 are satisfied.

First, the test case generation unit 24 determines whether or not the test cases 36 can be generated with respect to Method 1.

Referring to the example illustrated in FIG. 12, the test case generation unit 24 determines whether or not the test cases 36 that satisfy the condition of the branch coverage can be generated. Specifically, the test case generation unit 24 generates the test cases 36 in which under the conditions of the input conditions in the target patterns, the arrival points in the target patterns are passed through. If the test cases 36 can be generated, the test case generation unit 24 determines that the generation is possible. If the test cases 36 cannot be generated, the test case generation unit 24 determines that the generation is not possible. By generating the test cases 36 under the conditions of the input conditions in the target patterns and determining whether or not all the arrival points are passed through, the test case generation unit 24 can determine whether or not the test cases 36 can be generated.

If the test cases 36 cannot be generated, the test case generation unit 24 determines the requirement implementation degree to be nonexecutable.

If the test cases 36 can be generated with respect to Method 1, the test case generation unit 24 subsequently determines whether or not the test cases 36 can be generated with respect to Method 2.

Referring to the example illustrated in FIG. 12, the test case generation unit 24 determines whether or not the test cases 36 that simultaneously satisfy both of conditions of the equivalence partitioning and the branch coverage can be generated. Specifically, the test case generation unit 24 generates the test cases 36 which satisfy the respective three rows of the equivalence partitioning illustrated in FIG. 14 and in which the arrival points in the target patterns are passed through under the input conditions and the output conditions in the target patterns. If each of the test cases 36 can be generated, the test case generation unit 24 determines that the generation is possible. If one of the test cases 36 cannot be generated, the test case generation unit 24 determines that the generation is not possible. By generating the test cases 36 that satisfy the respective rows of the equivalence partitioning illustrated in FIG. 14 under the input conditions and the output conditions in the target patterns and determining whether or not all the arrival points are passed through, the test case generation unit 24 can determine whether or not the test cases 36 can be generated.

If the test cases 36 cannot be generated, the test case generation unit 24 determines the requirement implementation degree to be beyond the expected specifications.

If the test cases 36 can be generated with respect to Method 2, the test case generation unit 24 subsequently determines whether or not the test cases 36 can be generated with respect to Method 3.

Referring to the example illustrated in FIG. 12, the test case generation unit 24 determines whether or not the test cases 36 that simultaneously satisfy both of the conditions of the boundary value analysis and the branch coverage can be generated. Specifically, the test case generation unit 24 generates the test cases 36 which satisfy the respective four rows of the boundary value analysis illustrated in FIG. 14 and in which the arrival points in the target patterns are passed through under the input conditions and the output conditions in the target patterns. If each of the test cases 36 can be generated, the test case generation unit 24 determines that the generation is possible. If one of the test cases 36 cannot be generated, the test case generation unit 24 determines that the generation is not possible. By generating the test cases 36 that satisfies the respective rows of the boundary value analysis illustrated in FIG. 14 under the input conditions and the output conditions in the target patterns and determining whether or not all the arrival points are passed through, the test case generation unit 24 can determine whether or not the test cases 36 can be generated.

If the test cases 36 cannot be generated, the test case generation unit 24 determines the requirement implementation degree to be beyond the expected specifications.

If the test cases 36 can be generated with respect to Method 3, the test case generation unit 24 subsequently determines whether or not the test cases 36 can be generated with respect to Method 4. Method 4 is performed complimentarily as necessary and can be omitted.

Referring to the example illustrated in FIG. 12, the test case generation unit 24 determines whether or not the test cases 36 that satisfy the combination of the representative values (boundary values) can be generated. Specifically, the test case generation unit 24 generates the test cases 36 that satisfy the combination of the representative values (boundary values) illustrated in FIG. 14 under the input conditions and the output conditions in the target patterns. If the test cases 36 can be generated, the test case generation unit 24 determines that the generation is possible. If the test cases 36 cannot be generated, the test case generation unit 24 determined that the generation is not possible. By complementarily performing the process of generating the test cases 36 that satisfy the combination of the representative values (boundary values) illustrated in FIG. 14 as necessary under the input conditions and the output conditions in the target patterns, the test case generation unit 24 can determine whether or not the test cases 36 can be generated.

If the test cases 36 can be generated with respect to Method 4, the test case generation unit 24 subsequently determines whether or not the value of each output signal matches an expected value with respect to Method 5, using each test case 36 generated by Method 4 as an input.

Referring to the example illustrated in FIG. 12, the test case generation unit 24 executes the Back-to-Back test using the input signals of each test case 36 generated in Method 4 as inputs and determines whether or not the value of each output signal matches the expected value.

If the value of each output signal matches the expected value, the test case generation unit 24 determines the execution of the expected operation to be the success. On the other hand, if the value of each output signal does not match the expected value, the test case generation unit 24 determines the execution of the expected operation to be checked when a target portion of the test case is a functionally modified portion. When the target portion of the test case is an implementation modified portion rather than the functionally modified portion, the test case generation unit 24 determines the execution of the expected operation to be the failure.

The test case generation unit 24 extracts, from the test cases 36 generated with respect to the above-mentioned Method 4, at least one test case 36 associated with each input condition 31, each output condition 32, and each arrival point. When Method 4 is omitted, the test case generation unit 24 extracts one or more test cases 36 from the test cases 36 generated with respect to Method 3. With this arrangement, the one or more test cases 36 that can simultaneously guarantee the function-based coverage in (Requirement 1) and the structure-based coverage in (Requirement 2) can be obtained.

The test case generation unit 24 may stop the process illustrated in FIG. 11 at a point of time when the at least one test case 36 associated with each input condition 31, each output condition 32, and each arrival point is generated. This can prevent executions of the processes for all the combinations and consumption of much processing time when the number of the combinations becomes immense.

Effects of First Embodiment

As mentioned above, with the test case generation apparatus 10 according to the first embodiment, the test cases 36 that can simultaneously guarantee the function-based coverage in Requirement 1 and the structure-based coverage in Requirement 2 can be obtained. Therefore, the test cases 36 without omission or the test cases 36 that are necessary and sufficient can be obtained.

The number of the test cases 36 tends to become immense in a product development project. However, according to the test case generation apparatus 10 of the first embodiment, the test cases 36 that are necessary and sufficient can be obtained. An amount of test work can be thereby reduced, thus contributing effective utilization of manpower resources.

Alternative Configurations

<First Variation>

In the first embodiment, the function of each unit in the test case generation apparatus 10 has been implemented by the software. As a first variation example, however, the function of each unit in the test case generation apparatus 10 may be implemented by hardware. A difference of this first variation example from the first embodiment will be described.

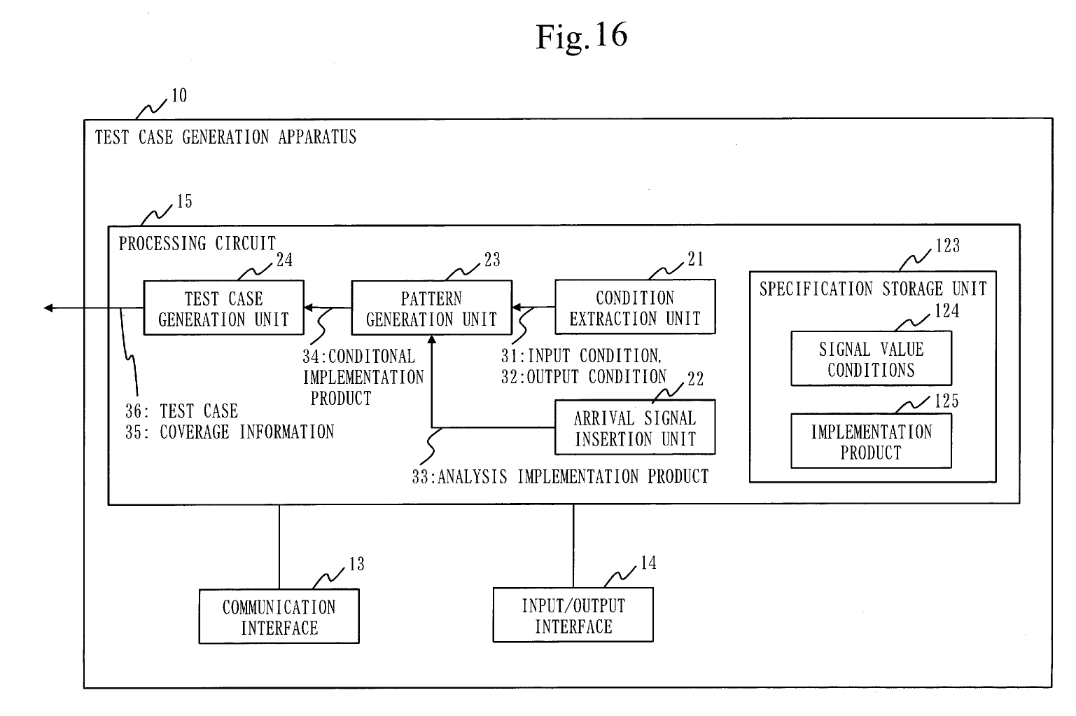

A configuration of a test case generation apparatus 10 according to the first variation example will be described with reference to FIG. 16.

When the function of each unit is implemented by the hardware, the test case generation apparatus 10 includes a processing circuit 15, in place of the processor 11 and the storage device 12. The processing circuit 15 is a dedicated electronic circuit to implement the function of each unit in the test case generation apparatus 10 and a function of the storage device 12.

As the processing circuit 15, a single circuit, a composite circuit, a programmed processor, a parallel-programmed processor, a logic IC, a gate array (GA), an application specific integrated circuit (ASIC), or a field-programmable gate array (FPGA) are assumed.

The function of each unit may be implemented by one processing circuit 15, or the function of each unit may be distributed into a plurality of the processing circuits 15 and may be implemented.

<Second Variation>

As a second variation example, a part of the functions may be implemented by hardware, and the other functions may be implemented by software. That is, the part of the functions of the respective units in the test case generation apparatus 10 may be implemented by the hardware, and the other functions may be implemented by the software.

The processor 11, the storage device 12, and the processing circuit 15 are collectively referred to as “processing circuitry”. That is, the function of each unit is implemented by the processing circuitry.

### Second Embodiment

A second embodiment is different from the first embodiment in that it is determined plurality of times whether or not a test case 36 can be generated with respect to each combination. This difference will be described in the second embodiment.

A target system 30 may hold an internal state, and a process such as an arithmetic operation, branching, or looping may be changed according to the internal state that is held. Therefore, correct determination may not be able to be made if it is determined only once whether or not the test case 36 can be generated with respect to each combination. That is, even with respect to a combination determined to be beyond expected specifications or nonexecutable, there may be a case where the combination may be within a specification range by a change in the internal state, so that the test case 36 can be generated.

Description of Operations

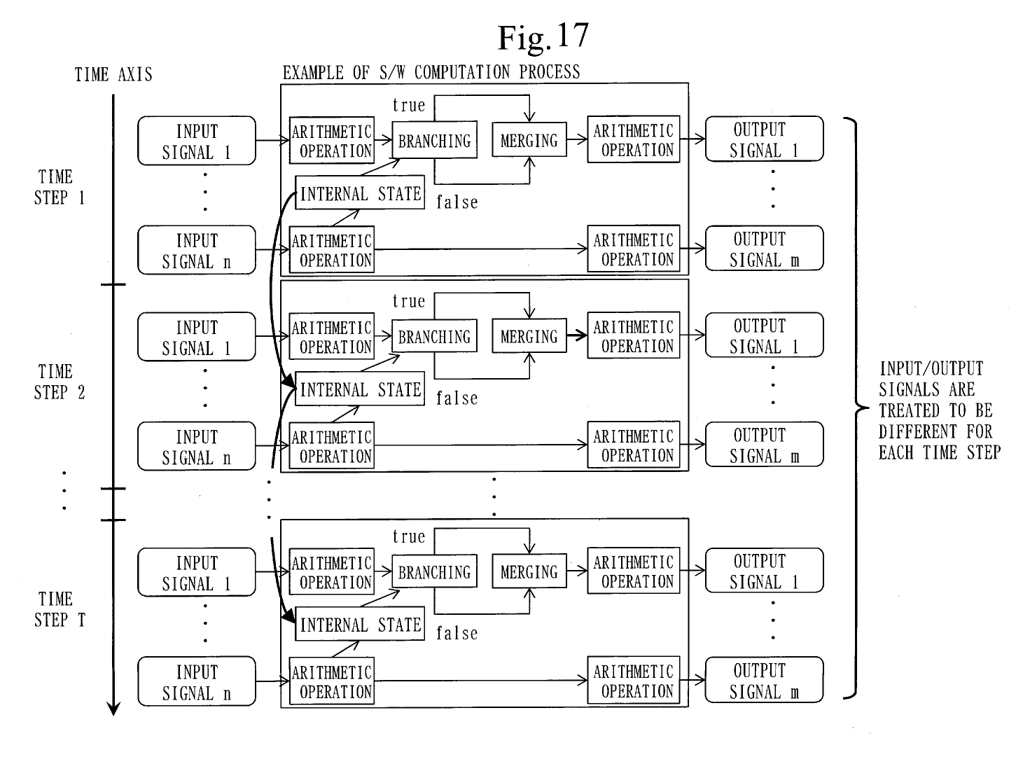

Operations of a test case generation apparatus 10 according to the second embodiment will be described with reference to FIG. 3 and FIG. 17.

The operations of the test case generation apparatus 10 according to the second embodiment correspond to a test case generation method according to the second embodiment. The operations of the test case generation apparatus 10 according to the second embodiment correspond to a test case generation program procedure according to the second embodiment.

Processes from step S1 to step S3 in FIG. 3 are the same as those in the first embodiment.

(Step S4 in FIG. 3: Test Case Generation Process)

As illustrated in FIG. 17, a test case generation unit 24 divides a time axis into discrete time steps each for executing processes of the target system 30 once. Then, just the number of conditional implementation products 34 with respect to the target pattern corresponding to the number of the time steps are arranged, thereby constituting one repetition system 37. In this case, each target system 30 constituting the repetition system 37 is assumed to take over an internal state at a point of time when the processes in a preceding time step have been finished. Further, each of input signals and output signals is treated to be different for each time step.

Similarly to the first embodiment, the test case generation unit 24 determines whether or not generation of a test case 36 for the repetition system 37, which enables checking of at least one of an input-output condition being a pair of an input condition and an output condition and an arrival point in each target pattern, is possible. With this arrangement, even when the test case 36 cannot be generated in a time step 1, the test case 36 may be able to be generated in a time step 2.

The number of the time steps is determined by a user based on a relationship between the number assumed to be necessary for making correct determination for the target system 30 and a processing period of time for generating each test case 36.

Effect of Second Embodiment

As mentioned above, the test case generation apparatus 10 according to the second embodiment determines whether or not the test case 36 can be generated after constituting the repetition system 37. With this arrangement, determination as to whether or not the test case 36 can be generated can be more correctly made than in the first embodiment.

### REFERENCE SIGNS LIST

10: test case generation apparatus; 11: processor; 12: storage device; 121: memory; 122: storage; 123: specification storage unit; 124: signal value conditions; 125: implementation product; 13: communication interface; 14: input/output interface; 15: processing circuit; 21: condition extraction unit; 22: arrival signal insertion unit; 23: pattern generation unit; 24: test case generation unit; 30: target system; 31: input condition; 32: output condition; 33: analysis implementation product; 34: conditional implementation product; 35: coverage information; 36: test case; 37: repetition system

1-8. (canceled)

9. A test case generation apparatus comprising:
processing circuitry to:
generate combination patterns indicating combinations of a plurality of input conditions for input signals for a target system, a plurality of output conditions for output signals for the target system, and a plurality of arrival points in the target system each at which attainment of a process is confirmed by a test method based on a software structure; and
set, as a target pattern, each of the combinations indicated by the generated combination patterns and determine whether or not generation of a test case that comprises values of the input signals and enables simultaneous checking of an input-output condition and a corresponding one of the plurality of arrival points in the target pattern is possible, thereby identifying a set of test cases that enable checking of each of the plurality of input conditions, each of the plurality of output conditions, and each of the plurality of arrival points, the input-output condition being a pair of an input condition and an output condition in the target pattern.

10. The test case generation apparatus according to claim 9,
wherein the processing circuitry generates the test cases with respect to the combinations that enable checking of each of the plurality of input conditions, each of the plurality of output conditions, and each of the plurality of arrival points, from among the combinations each for which the generation has been determined to be possible.

11. The test case generation apparatus according to claim 9,
wherein the processing circuitry determines whether the test case for the target pattern can be generated with respect to each of a first method, a second method, and a third method, thereby determining whether at least one of the input-output condition and the arrival point may be checked, the first method being a test method based on the software structure, the second method being a combination of a test method based on a software function and the test method based on the software structure, and the third method being a combination of the test method based on the software structure and a test method based on the software function and having a criterion being more stringent than the second method.

12. The test case generation apparatus according to claim 11,
wherein with respect to each of the first method, the second method, and the third method, the processing circuitry generates the test cases for the combinations each for which the generation of the test case has been determined to be possible.

13. The test case generation apparatus according to claim 12,
wherein the processing circuitry determines whether or not a value obtained by inputting each of the generated test cases to the target system matches an expected value.

14. The test case generation apparatus according to claim 11,
wherein the processing circuitry determines the target pattern to be nonexecutable when the test case cannot be generated with respect to the first method, determines the target pattern to be beyond expected specifications of the target system when the test case can be generated with respect to the first method and cannot be generated with respect to the second method or the third method, and determines the target pattern to be within a specification range of the target system when the test case can be generated with respect to the first method, the second method, and the third method.

15. The test case generation apparatus according to claim 9,
wherein in a repetition system where a process of the target system is repetitively executed a plurality of times with an internal state of the target system retained, the processing circuitry determines whether or not generation of the test case that enables checking of at least one of the input-output condition and the arrival point is possible.

16. A non-transitory computer readable medium storing a test case generation program to cause a computer to execute:
a pattern generation process of generating combination patterns indicating combinations of a plurality of input conditions for input signals for a target system, a plurality of output conditions for output signals for the target system, and a plurality of arrival points in the target system each at which attainment of a process is confirmed by a test method based on a software structure; and
a test case generation process of setting, as a target pattern, each of the combinations indicated by the combination patterns generated by the pattern generation process and determining whether or not generation of a test case that comprises values of the input signals and enables simultaneous checking of an input-output condition and a corresponding one of the plurality of arrival points in the target pattern is possible, thereby identifying a set of test cases that enable checking of each of the plurality of input conditions, each of the plurality of output conditions, and each of the plurality of arrival points, the input-output condition being a pair of an input condition and an output condition in the target pattern.
